(19) United States
(12) Patent Application Publication
(10) Pub. No.: US 2012/0295358 A1
(43) Pub. Date: Nov. 22, 2012

(54) Magnetic Conveyor Systems, Apparatus and Methods Including Moveable Magnet

(75) Inventors: Gregory Ariff, Newark, DE (US); Timothy Evers, Wilmington, DE (US); Milind Sawant, Newark, DE (US); Tumkur Vijay, Newark, DE (US)

(73) Assignee: Siemens Healthcare Diagnostics Inc., Tarrytown, NY (US)

(21) Appl. No.: 13/574,036

(22) PCT Filed: Jan. 20, 2011
(86) PCT No.: PCT/US11/21810

§ 371 Date: Jul. 19, 2012

Related U.S. Application Data
(60) Provisional application No. 61/296,998, filed on Jan. 21, 2010.

(51) Int. Cl. G01N 35/04

(52) U.S. Cl. 436/47; 422/65

(57) ABSTRACT

Disclosed are magnetic conveyor systems and apparatus having a magnetic coupling with a housing and moveable magnet therein. The moveable magnet is substantially constrained in one dimension and adapted to move in another. The moveable magnet is adapted to magnetically couple with an attracting portion of a sample rack and move the rack along a conveying surface. Ease of transfer of sample racks is provided while minimizing spillage from the open sample containers therein. Method of operating the conveyor system are provided, as are other aspects.

### FIELD OF THE INVENTION

The present invention relates generally to apparatus, systems and methods for conveying sample racks to and from clinical analyzers.

### BACKGROUND OF THE INVENTION

In the testing of bodily fluid samples (otherwise referred to as “specimens”) in automated testing systems (e.g., clinical analyzers), sample containers (such as test tubes, sample cups, vials, and the like) may be conveyed in sample racks along a conveyor system to the test system. One type of conveyor system couples magnetically to sample racks to move the racks along a conveying surface. The act of magnetically coupling to the racks may, in operation, contribute to spillage of the fluid samples in the sample containers. Accordingly, apparatus, systems and methods are desired that may allow for less disruption of the sample containers and sample racks as they are being conveyed to and from the clinical analyzer thereby reducing the propensity for spillage from the sample containers.

### SUMMARY OF THE INVENTION

According to a first aspect, an improved magnetic conveyor system is provided. The magnetic conveyor system includes a conveying surface along which a sample rack containing one or more sample containers is adapted to be conveyed, the sample rack including an attracting portion; and a magnetic coupling situated adjacent to the conveying surface and moveable along a direction of the conveying surface, the magnetic coupling including a housing, and a moveable magnet adapted to move relative to the housing and, in operation, magnetically couple with the attracting portion as the magnetic coupling is traversed adjacent to the sample rack, and wherein relative movement of the moveable magnet within the housing is substantially restrained in a direction parallel to the conveying surface and is moveable in a direction perpendicular to the conveying surface.

In a method aspect, an improved method of conveying a sample rack is provided. The method of conveying a sample rack includes providing a conveying surface along which the sample rack containing one or more sample containers is adapted to be conveyed, the sample rack including an attracting portion; providing a conveyor component having a magnetic coupling thereon, the magnetic coupling including a housing and a moveable magnet; and moving the conveyor component so that the magnetic coupling is positioned adjacent to the sample rack on the conveying surface so that the moving magnet magnetically couples with the attracting portion to convey the sample rack on the conveyor surface, and wherein relative movement of the moveable magnet within the housing is substantially restrained in a direction parallel to the conveying surface and is moveable in a direction perpendicular to the conveying surface.

In an apparatus aspect, an improved sample rack conveyor apparatus is provided. The apparatus includes a conveyor belt including a belt surface; and a magnetic coupling provided on the conveyor belt, the magnetic coupling including: a housing, and a moveable magnet adapted to move relative to the housing and, in operation, magnetically couple with an attracting portion of a sample rack as the magnetic coupling is traversed adjacent to the sample rack wherein relative movement of the moveable magnet within the housing is substantially restrained in a direction parallel to the belt surface and is moveable in a direction perpendicular to the belt surface.

Still other aspects, features, and advantages of the present invention may be readily apparent from the following detailed description by illustrating a number of exemplary embodiments and implementations, including the best mode contemplated for carrying out the present invention. The present invention may also be capable of other and different embodiments, and its several details may be modified in various respects, all without departing from the spirit and scope of the present invention. Accordingly, the drawings and descriptions are to be regarded as illustrative in nature, and not as restrictive. The drawings are not necessarily drawn to scale. The invention is to cover all modifications, equivalents, and alternatives falling within the spirit and scope of the invention.

### BRIEF DESCRIPTION OF THE DRAWINGS

FIG. 1 is a side view illustration of an exemplary magnetic conveyor system including a fixed magnet according to the prior art.

FIG. 2 is a cross-sectioned side view illustration of an exemplary magnetic conveyor system including a magnetic coupling shown misaligned with the sample rack according to embodiments of the present invention.

FIG. 3 is a cross-sectioned side view illustration of an exemplary magnetic conveyor system including a magnetic coupling aligned with the sample rack according to embodiments of the present invention.

FIG. 4 is an isometric illustration of the magnetic conveyor system installed as part of a rack delivery system for a clinical analyzer according to embodiments of the invention.

FIG. 5 is an isometric illustration of a magnetic conveyor apparatus including a plurality of magnetic couplings according to embodiments of the invention.

FIG. 6 is a cross-sectioned side view illustration of a magnetic conveyor system including a plurality of magnetic couplings conveying sample racks according to embodiments of the invention.

FIG. 7 is an isometric view of a housing of the magnetic coupling according to embodiments of the invention.

FIG. 8 is a top view of the housing of the magnetic coupling according to embodiments of the invention.

FIG. 9 is a side view of a housing of the magnetic coupling according to embodiments of the invention.

FIG. 10 is a bottom view of a housing of the magnetic coupling according to embodiments of the invention.

FIG. 11 is a cross-sectioned side view of the housing of FIG. 10 taken along lines 111-11 according to embodiments of the invention.

FIG. 12 is an isometric view of a moveable magnet according to embodiments of the invention.

FIG. 13 is an isometric view of an absorber according to embodiments of the invention.

FIG. 14 is a flowchart illustrating methods according to embodiments of the present invention.

### DETAILED DESCRIPTION

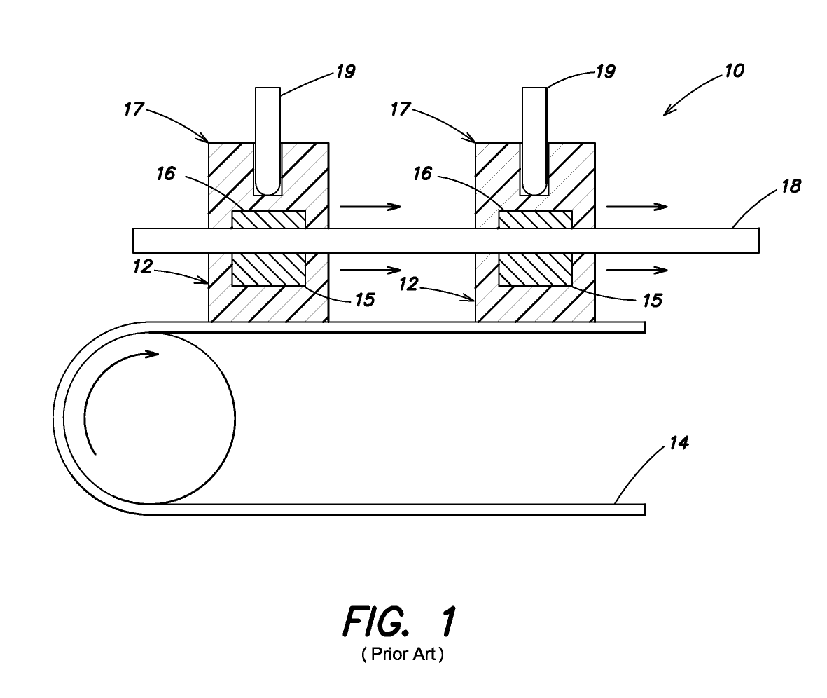

In prior art magnetic conveyor systems 10, as best shown in FIG. 1, magnetic couplings 12 mounted to a conveyor belt 14 include fixed magnets 15 which magnetically couple with ferromagnetic members 16 of sample racks 17 to move the sample racks along a conveyor surface 18. The sample racks 17 carry one or more sample containers 19 and include the ferromagnetic member 16, such as a steel plate, on a bottom thereof. Increasing a strength of the conveying magnets improves reliability of transport. The inventors herein recognized that as the field strength of the conveying magnets is increased, such prior art systems may accelerate the rack unacceptably fast when the magnet 15 of the magnetic coupling 12 approaches the sample rack 17. This may result the rack 17 jumping towards the magnetic coupling 12 and spillage of the sample fluid contained in the open sample container 19. This spillage condition may be unacceptable because it may result in loss of the patient sample, contaminate the clinical analyzer (not shown), the conveyor surface 18, possibly mix sample fluid in sample containers being conveyed with other sample fluids contained in other sample containers 19, and possibly necessitate analyzer down time for cleaning/maintenance.

In view of the foregoing difficulties, there is an unmet need to reduce the propensity for spillage from such sample containers caused by jumping of the sample rack when conveyed by magnetic conveyor systems. To address this need, embodiments according to aspects of the present invention provide a magnetic conveyor system and magnetic conveyor apparatus, which includes a moveable magnet. The magnetic conveyor system includes a conveying surface (e.g., a low-friction planar surface) along which a sample rack containing one or more sample containers is adapted to be conveyed. The sample rack includes an attracting portion. A magnetic coupling is situated adjacent to (e.g., underneath) the conveying surface and moveable along a direction of the conveying surface (e.g., along a linear vector path). The magnetic coupling includes a housing and moveable magnet adapted to move relative to the housing. In operation, the moveable magnet magnetically couples with the attracting portion of the sample rack as the magnetic coupling is traversed adjacent to the sample rack on the conveying surface. Relative movement of the moveable magnet within the housing is substantially restrained in a direction parallel to the conveying surface, yet is freely moveable in a direction perpendicular to the conveying surface (e.g., along an axial axis of a channel within the housing). As a result, the moveable magnet moves closer to the conveying surface as the magnetic coupling approaches the rack. Accordingly, acceleration of the sample rack is reduced without reducing the pulling force acting on the sample rack when the magnetic coupling is aligned with the sample rack. This may lead to relatively less spillage.

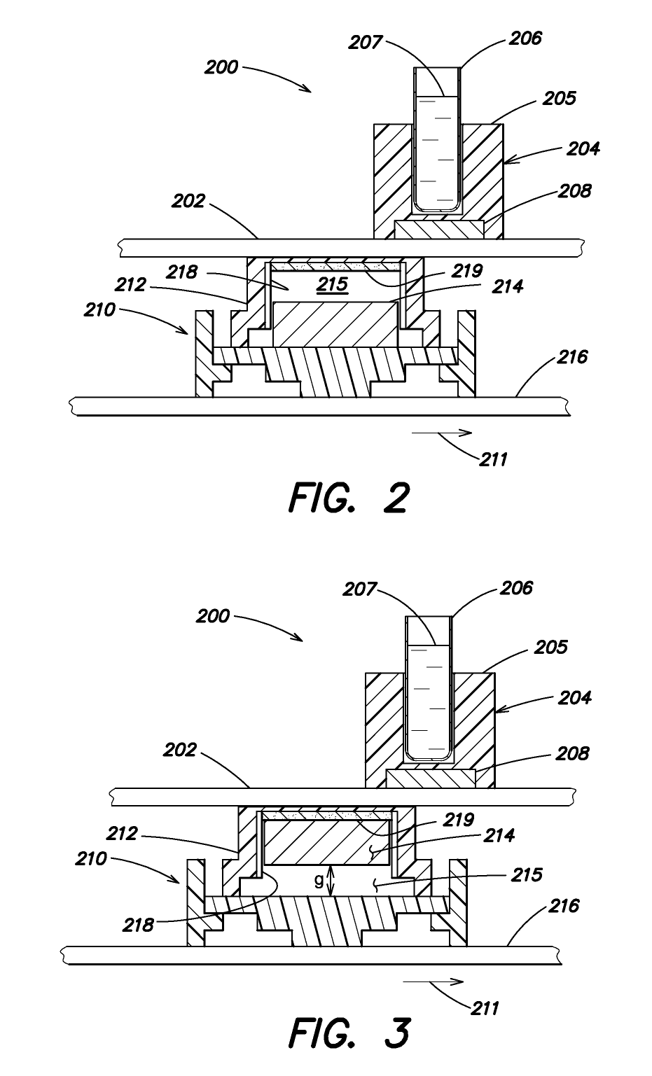

These and other aspects and features of the invention will be described with reference to FIGS. 2-14 herein.

In accordance with a first embodiment of the invention, as best shown in FIGS. 2 and 3, a magnetic conveyor system 200 is described. The magnetic conveyor system 200 includes a conveying surface 202 on which a sample rack 204, containing one or more sample containers 206, is adapted to be conveyed. The sample container 206 may be a test tube, cup, vial, or any other form of container, and is adapted to receive a sample fluid 207 (e.g., blood, plasma, urine, interstitial fluid, or the like) to be conveyed. The sample rack 204 includes a body 205 and an attracting portion 208 provided in the body 205, which may be a ferromagnetic member such as a steel slug, puck, or plate. For example, the attracting portion 208 may be manufactured from a ferromagnetic material such as a stainless steel material (e.g., 400 series stainless). Optionally, the attracting portion 208 may be manufactured from a ferromagnetic steel material with a surface plating, such as a zinc plating. The attracting portion 208 may be received in a recess formed in a bottom of the body 205 of the rack 204 and secured therein via an adhesive, press fit, or suitable mechanical means (e.g., bolting or screwing). The body 205 of the sample rack 204 may be plastic or other suitable low-friction material. The conveyor surface 202 may be any generally planar, low-friction surface. For example, the conveyor surface 202 may have a thin coating of Teflon provided on an aluminum plate having a thickness of about 0.09 inch (about 2.3 mm) thickness. However, any nonmagnetic material may be used as the plate.

The magnetic conveyor system 200 further includes one or more magnetic couplings 210 (preferably a plurality of magnetic couplings 210) situated and configured for movement adjacent to the conveying surface 202. For example, the magnetic couplings 210 may be provided on a side of the conveying surface 202 opposite from the rack 204 (e.g., underneath the conveying surface 202). The one or more magnetic couplings 210 are relatively moveable along a direction of the conveying surface 202 as indicated by arrows 211 indicating forward movement. It should, however, be understood that the present conveyor system 200 may be used to convey racks 202 in either the forward or reverse directions, i.e., to and from a clinical analyzer provided at one end of the conveyor system 200.

Each magnetic coupling 210 includes a housing 212, and a moveable magnet 214 received in a channel 215 of the housing 212. The moveable magnet 214 is adapted to move (e.g., slide) in the channel 215 relative to the housing 212 and, in operation, magnetically couple with the attracting portion 208 as the magnetic coupling 210 is traversed adjacent to the sample rack 204 by the movement of a conveyor component 216. One exemplary conveyor component 216 is a conveyor belt, which is configured to move the magnetic couplings 210 along a path adjacent to the conveying surface 202. However, any suitable conveyor component 216 may be used, such as a chain, band, cable, strap, ball screw, linear bearing, etc.

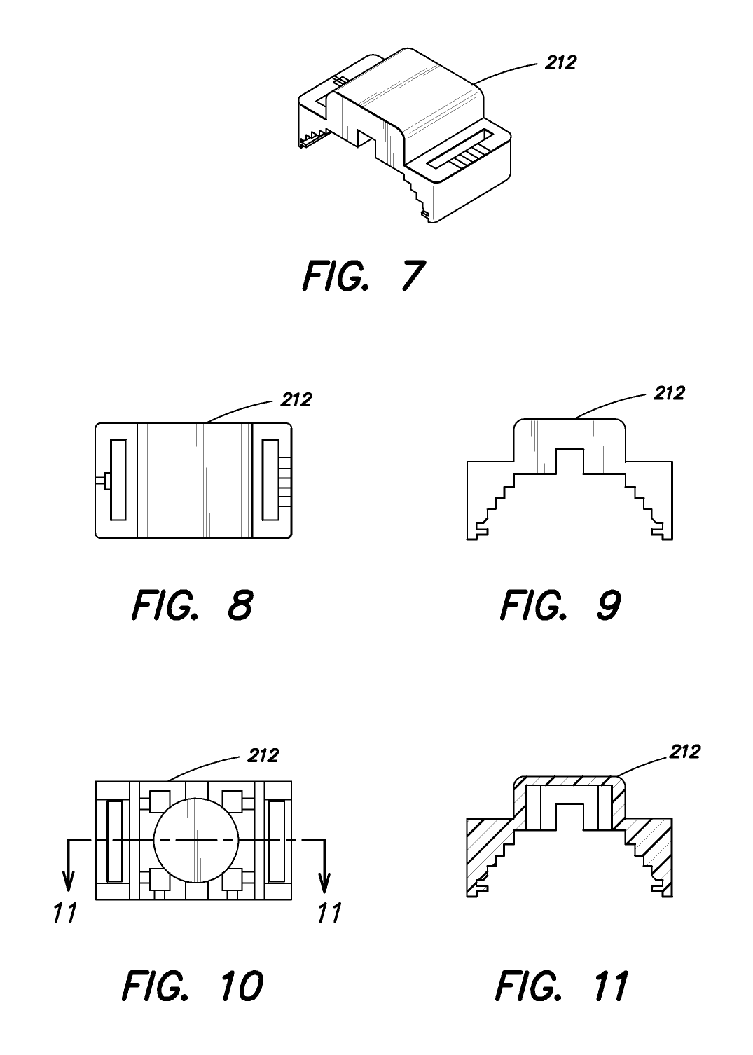

The relative movement of the moveable magnet 214 within the channel 215 of the housing 212 is substantially restrained in a direction parallel to the plane of the conveying surface 202 (e.g., lateral motion as shown in FIGS. 2 and 3). The moveable magnet 214 is free to move (e.g., reciprocate) in a direction perpendicular to the plane of the conveying surface 202 (e.g., vertically, as shown). In particular, the moveable magnet 214 is constrained in the housing 212 from sidewise movement by sidewalls 218 of the channel 215 formed in the housing 212, but is allowed to move along an axial axis of the channel 215. There may be slight gap/play between the sidewalls 218 and the magnet 214 so that the magnet 214 may slide and not bind within the channel. The magnet 214 needs to have a field strength that is strong enough to move in the direction of free movement so as to couple with the sample rack 204. In some embodiments, a spring (not shown) may be added to assist the movement of the magnet 214 in the axial direction within the channel 215. Further views of an exemplary housing 212 are depicted in FIGS. 7-11.

In the depicted embodiment of FIGS. 2-3, the sidewalls 218 may include two or more vertically-oriented ribs positioned at radial locations about a radial periphery of the moveable magnet 214, but slightly spaced therefrom, such that the magnet may freely slide along an axial axis of the channel 215 in the housing 212 (e.g., in a vertical direction as shown). The ribs of the sidewall 218 may have a narrow width and may lower the friction acting on the magnet 214 by reducing a sliding contact area between the channel 215 and the magnet 214. The housing 212 may include other means for reducing friction, such as a suitable lubrication (e.g., oil, Teflon, graphite, etc.). Further, the housing 212 may be made of a low-friction material, such as a treated plastic (e.g., LUBRILOY™) which may be molded or machined. LUBRILOY™ is a polycarbonate material available from SABIC Innovative Plastics.

The housing 212 may be connected to the conveyor component 216 (e.g., belt) via any suitable means, such as bolting, screwing, adhesive bonding, clamping, or the like. In other embodiments, the housing 212 may be formed to be integral with the conveyor component 216. For example, a portion of the housing 212 may be integrally bonded to a polyurethane belt of a conveyor belt.

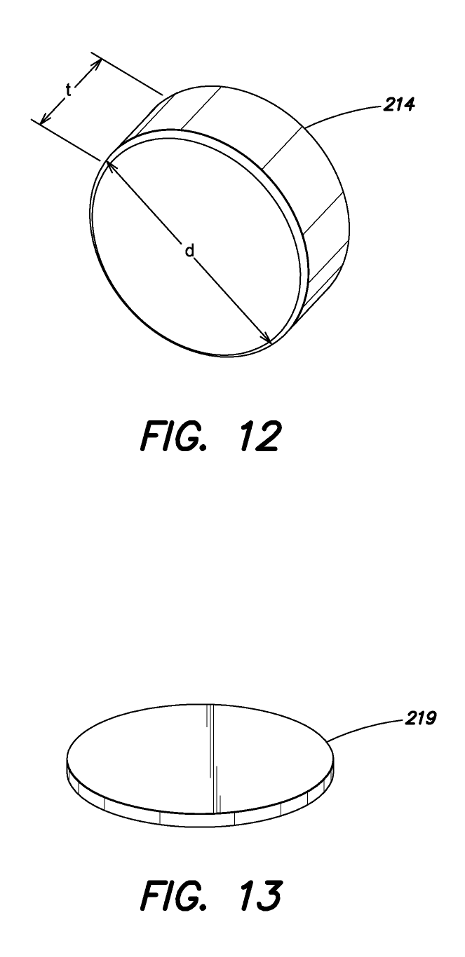

In the present embodiment, the magnet 214 may be any suitable high strength magnet, such as a neodymium magnet. The magnet 214 may include a plated surface, such as a zinc plating, and may be of any suitable strength needed to pull the loaded racks 204 along the conveying surface 202. A 38 MGO disc-shaped magnet (see FIG. 12) having a disc shape and an axial thickness (t) of about 0.25 inch (about 6.4 mm) and an outer diameter (d) of about 0.625 inch (about 15.9 mm) was found to adequately attract the attracting portion 208 and is sufficient to smoothly pull half the weight of a rack 204 loaded with five sample containers 206 along the conveying surface 202 of a conveyor system 200.

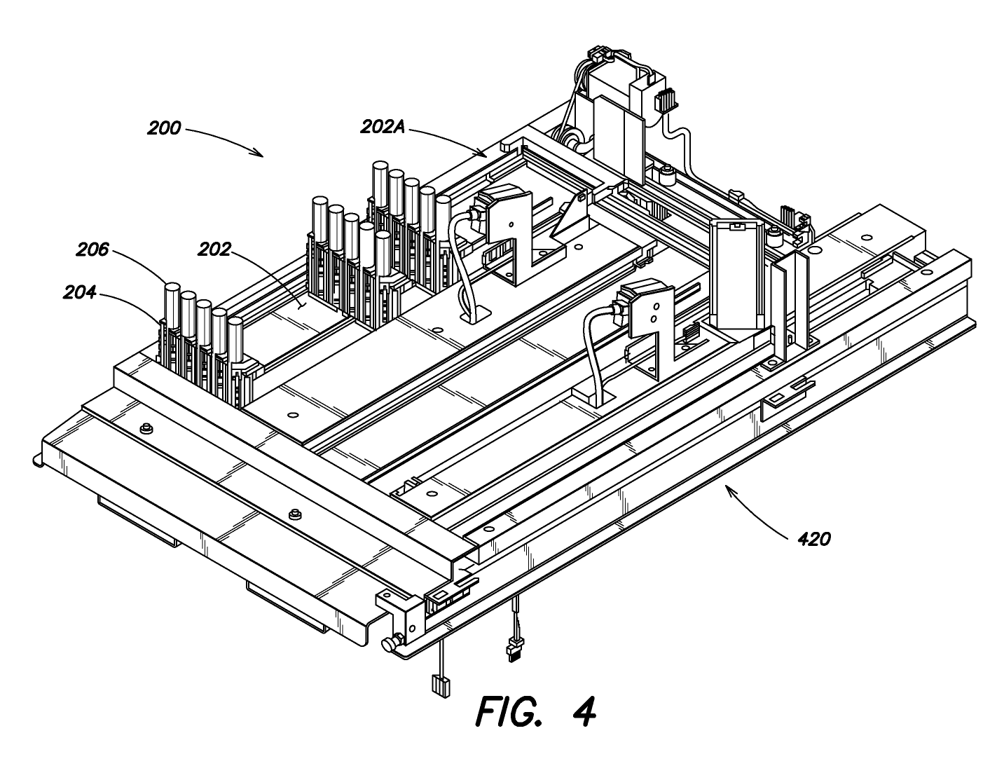

The conveyor system 200 may be part of a conveyor assembly 416, such as shown in FIG. 4. The conveyor assembly is adapted to convey one or more sample racks 204 containing one or more sample containers 206 along the conveyor surface 202 to (or to and from) a location at an end of the conveying surface 202A. The end of the conveying surface 202A may be a location where the sample racks 204 may be accessed by a clinical analyzer (not shown). For example, the entire rack 206 located at the end 202A may be picked and placed into a clinical analyzer, where tests may be carried out on the sample fluids contained in the sample containers 206, or a probe (not shown) may simply access the sample container at the end 202A.

According to some embodiments, such as the embodiment shown in FIGS. 2-3, the channel 215 may include an absorber 219 located and positioned on at least one end thereof, which is adapted to damp an impact of the moveable magnet 214 as it moves from an “at rest position” as shown in FIG. 2 to an “activated position” as shown in FIG. 3. In the activated position, the moving magnet 214 is attracted to, and moves to, a fixed position closest to the attracting portion 208, i.e., the moveable magnet 214 comes into contact with the absorber 219. The gap distance (g) that the moveable magnet 214 moves may vary based upon design considerations such as the weight of the rack 204 and sample containers 206, and strength of the magnet 214, but a gap of about 0.187 inch (about 4.8 mm) is found to be sufficient for the magnets 214 described herein. The gap (g) should be small enough so that the magnet 214 can pull itself up to the activated position in the housing 212 as the magnetic coupling 210 is moved along the path and into the proximity of the rack 204, as shown in FIG. 3.

The absorber 219, as best seen in FIG. 13, may be manufactured from any suitable absorbing material, which is adapted to reduce the sound and/or impact of the moving magnet 214 as it moves to the activated position. For example, the absorber 219 may be solid or foamed elastomer material such as silicone, or a synthetic or natural rubber material, a spring, a felt material, or the like. A disc-shaped silicone foam pad having a thickness of about 0.1875 inch (about 5 mm) thick was found to sufficiently damp the impact of the magnet 214 described herein. The absorber 219 may be secured to the underside of the housing 212 and positioned at the end of the channel 215 via an adhesive or the like (e.g., a pressure sensitive adhesive).

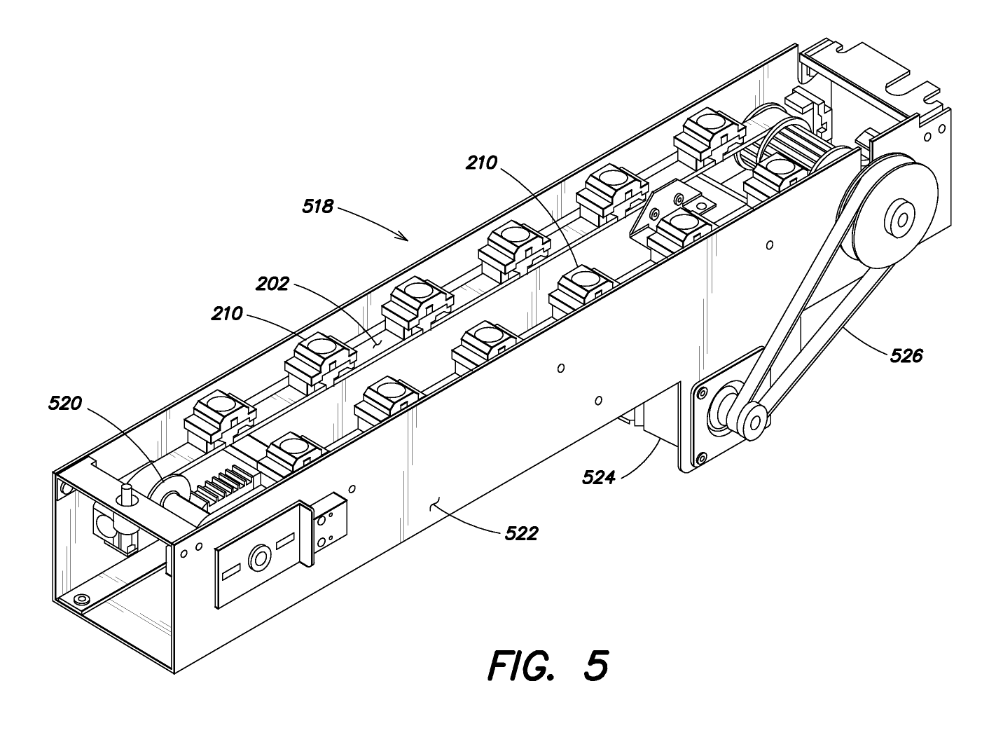

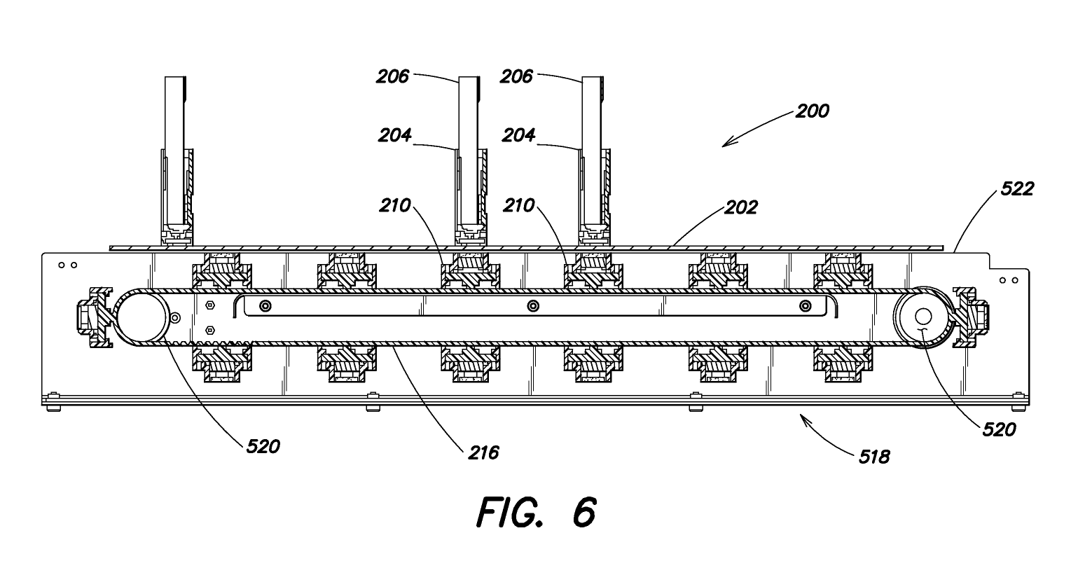

In some embodiments, such as the FIG. 5 embodiment, only half the weight of each sample rack 204 is pulled along by each of two cooperating and sidewise-aligned magnet couplings 210. For example, the magnetic conveyor apparatus 518 the of the conveyor system 200, as best shown in FIGS. 5 and 6, pulls the racks 204 along the conveyor surface 202 when the magnet couplings 210 attract to attractive portions 208 (FIG. 3) provided at either end of the rack 204 (one on either end of the sample rack 204). Thus, the magnetic conveyor system 200 may convey the sample racks 204 evenly, and without rotation, as they traverse along the conveying surface 202.

As can be seen from FIGS. 5-6, the magnetic conveyor apparatus 518 may include a number of conveyor wheels 520 upon which the conveyor component 216 (e.g., a conveyor belt) is entrained. The wheels 520 may be mounted for rotation relative to a frame 522 by axles or the like, and the wheels 520 and conveyor component 216 may be driven by a suitable motor 524 and drive system 526. The conveyor component 216 and wheels 520 may includes cogs to aid in providing traction against the wheels 520.

One advantage of using the magnetic conveyor system 200, magnetic conveyor apparatus 518 and method, according to aspects of the invention, is that the propensity for spillage of fluid samples in the open sample containers 206 may be minimized by reducing lateral acceleration (jumping) of the rack 204 as the sample rack 204 is conveyed along the conveying surface 202. However, the conveying (pulling) force, which pulls the rack 204 along the conveying surface 202 is not diminished as compared to fixed magnet configurations. Further, the speed of conveying of the sample rack 204 may be increased as compared to prior systems. Additionally, the laterally-restrained magnet design allows for a smaller, more compact design of the magnetic coupling 210, possibly leading to smaller conveyor wheels, more couplings per unit length (i.e., higher coupling density). Furthermore, the conveyor system 200 is easily adapted to bi-directional movement of the sample racks 204 along the conveying surface 202.

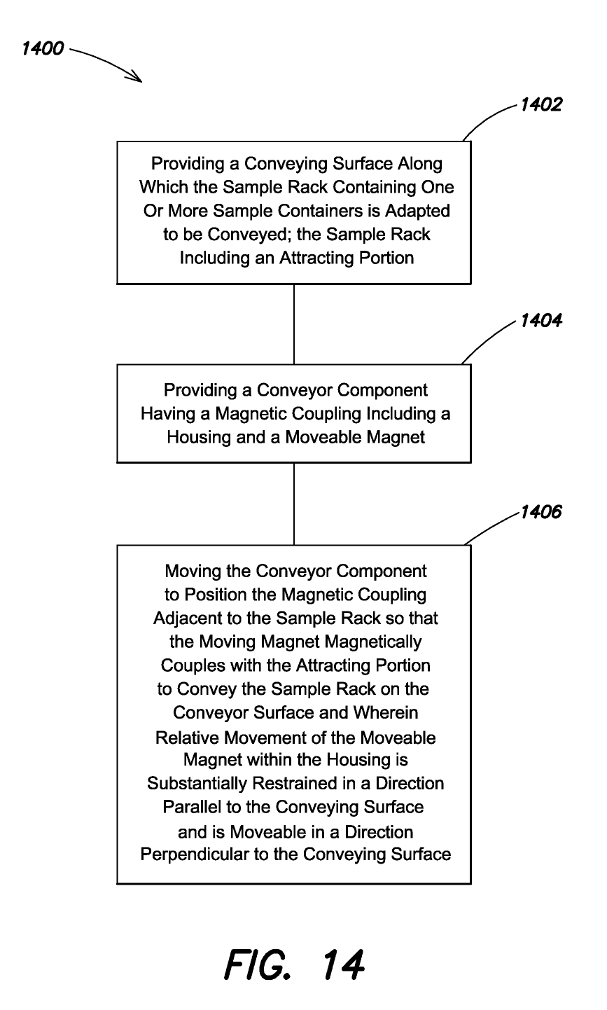

The operation of the present invention method will now be described in more detail with reference to FIG. 14. The method 1400 of conveying a sample rack includes, in 1402, providing a conveying surface 202 along which the sample rack 204 containing one or more sample containers 206 is adapted to be conveyed; the sample rack including an attracting portion 208; in 1404, providing a conveyor component 216 having a magnetic coupling 210 thereon, the magnetic coupling 210 including a housing 212 and a moveable magnet 214; and in 1406, moving the conveyor component 216 so that the magnetic coupling 210 is positioned adjacent to the sample rack 204 on the conveying surface 202 such that the moving magnet 214 magnetically couples with the attracting portion 208 to convey the sample rack 204 on the conveyor surface 202 and wherein relative movement of the moveable magnet 214 within the housing 212 is substantially restrained in a direction parallel to the conveying surface 202 and is freely moveable in a direction perpendicular to the conveying surface 202.

While the invention is susceptible to various modifications and alternative forms, specific system and apparatus embodiments and methods thereof have been shown by way of example in the drawings and are described in detail herein. It should be understood, however, that it is not intended to limit the invention to the particular systems, apparatus or methods disclosed, but, to the contrary, the intention is to cover all modifications, equivalents and alternatives falling within the spirit and scope of the invention.

What is claimed is:

1. A magnetic conveyor system, comprising:
a conveying surface along which a sample rack containing one or more sample containers is adapted to be conveyed, the sample rack including an attracting portion; and
a magnetic coupling situated adjacent to the conveying surface and moveable along a direction of the conveying surface, the magnetic coupling including:
a housing, and
a moveable magnet adapted to move relative to the housing and, in operation, magnetically couple with the attracting portion as the magnetic coupling is traversed adjacent to the sample rack wherein relative movement of the moveable magnet within the housing is substantially restrained in a direction parallel to the conveying surface and is moveable in a direction perpendicular to the conveying surface.

2. The magnetic conveyor system of claim 1, wherein the housing includes a channel in which the moveable magnet translates.

3. The magnetic conveyor system of claim 2, wherein the channel includes an absorber on at least one end thereof, which is adapted to damp an impact of the moveable magnet.

4. The magnetic conveyor system of claim 1, wherein the attracting portion is a ferromagnetic member.

5. The magnetic conveyor system of claim 4, wherein the ferromagnetic member is a magnetic grade stainless steel.

6. The magnetic conveyor system of claim 1, wherein the attracting portion is positioned on a bottom portion of the sample rack.

7. The magnetic conveyor system of claim 1, wherein the magnetic coupling is mounted to a conveyor component and moveable along a direction of the conveying surface by the conveyor component.

8. The magnetic conveyor system of claim 1, wherein the moveable magnet moves vertically in a channel formed in the housing as the moveable magnet is positioned adjacent to the sample rack.

9. The magnetic conveyor system of claim 7, wherein a distance between an activated position and at rest position of the moveable magnet is between about 4 mm and 6 mm.

10. A method of conveying a sample rack, comprising:
providing a conveying surface along which the sample rack containing one or more sample containers is adapted to be conveyed, the sample rack including an attracting portion;
providing a conveyor component having a magnetic coupling thereon, the magnetic coupling including a housing and a moveable magnet; and
moving the conveyor component so that the magnetic coupling is positioned adjacent to the sample rack on the conveying surface so that the moving magnet magnetically couples with the attracting portion to convey the sample rack on the conveyor surface and wherein relative movement of the moveable magnet within the housing is substantially restrained in a direction parallel to the conveying surface and is moveable in a direction perpendicular to the conveying surface.

11. A sample rack conveyor apparatus, comprising:
a conveyor belt including a belt surface; and
a magnetic coupling provided on the conveyor belt, the magnetic coupling including:
a housing, and
a moveable magnet adapted to move relative to the housing and, in operation, magnetically couple with an attracting portion of a sample rack as the magnetic coupling is traversed adjacent to the sample rack, and wherein relative movement of the moveable magnet within the housing is substantially restrained in a direction parallel to the belt surface and is moveable in a direction perpendicular to the belt surface.
